(19) United States
(12) Patent Application Publication
(10) Pub. No.: US 2024/0186535 A1
(43) Pub. Date: Jun. 6, 2024

(54) PtNiN FUEL CELL ELECTRODE CATALYSTS AND FUEL CELLS WITH PtNiN ELECTRODE CATALYSTS

(71) Applicant: Toyota Motor Engineering & Manufacturing North America, Inc., Plano, TX (US)

(72) Inventors: Liang Wang, Saline, MI (US); Hongfei Jia, Ann Arbor, MI (US); Li Q. Zhou, Okemos, MI (US); Honghong Lin, Ann Arbor, MI (US); Kotaro Sasaki, Hauppauge, NY (US); Xueru Zhao, New York City, NY (US)

(73) Assignees: Toyota Motor Engineering & Manufacturing North America, Inc., Plano, TX (US); Toyota Jidosha Kabushiki Kaisha, Toyota-shi, Aichi-ken (JP); Brookhaven Science Associates LLC, Upton, NY (US)

(21) Appl. No.: 18/073,731

(22) Filed: Dec. 2, 2022

(51) Int. Cl. H01M 4/92; H01M 4/86; H01M 8/1004

(52) U.S. Cl. CPC H01M 4/926; H01M 4/8605; H01M 8/1004

(57) ABSTRACT

A fuel cell includes an anode, a cathode, and a polymer electrolyte membrane disposed between the anode and the cathode. A cathode catalyst is disposed on the cathode and the cathode catalyst includes nitrogen doped platinum nickel (PtNiN) nanoparticles loaded on mesoporous carbon. The PtNiN nanoparticles have an average diameter between about 1.0 nm and about 10.0 nm, the mesoporous carbon has a plurality of pores, the majority of the pores have an average pore diameter less than about 8.0 nm, and at least a portion of the PtNiN nanoparticles are disposed within the majority of the pores having an average pore diameter less than about 8.0 nm.

### STATEMENT REGARDING FEDERALLY SPONSORED RESEARCH OR DEVELOPMENT

The present invention was made with government support under contract number DE-SC0012704 awarded by the U.S. Department of Energy. The United States government may have certain rights in this invention.

### TECHNICAL FIELD

The present disclosure generally relates to catalyst, and particularly to PtNiN electrode catalysts for fuel cells and fuel cells with PtNiN electrode catalysts.

### BACKGROUND

Fuel cells with polymer electrolyte membranes (PEMs) are used as energy sources for transportation due to their high-power density, low operation temperatures, and zero emission of harmful gases. However, electrolytes used in PEM fuel cells can include one or more components that poison anode and/or cathode catalyst materials of a PEM fuel cell and thereby reduce the power output and efficiency thereof.

The present disclosure addresses the issue of poisoning of anode and/or cathode catalyst materials of PEM fuel cells, and other issues related to PEM fuel cells.

### SUMMARY

In one form of the present disclosure, a fuel cell includes an anode, a cathode, and a polymer electrolyte membrane disposed between the anode and the cathode. Also, a cathode catalyst is disposed on the cathode and the cathode catalyst includes nitrogen doped platinum nickel (PtNiN) nanoparticles loaded on mesoporous carbon. The PtNIN nanoparticles have an average diameter between about 1.0 nm and about 10.0 nm, the mesoporous carbon has a plurality of pores, the majority of the pores have an average pore diameter less than about 8.0 nm, and at least a portion of the PtNiN nanoparticles are disposed within the majority of the pores having an average pore diameter less than about 8.0 nm.

In another form of the present disclosure, a fuel cell includes an anode, a cathode, a polymer electrolyte membrane disposed between the anode and the cathode, and an ionomer in contact with the cathode. A cathode catalyst is disposed on the cathode and the cathode catalyst includes PtNiN nanoparticles loaded on mesoporous carbon. At least a portion of the PtNiN nanoparticles are disposed within pores of the mesoporous carbon and are spaced apart from the ionomer. The PtNiN nanoparticles have an average diameter between about 1.0 nm and about 10.0 nm and at least 85% of the pores of the mesoporous carbon have an average pore diameter less than about 8.0 nm.

In still another form of the present disclosure, a fuel cell includes an anode, a cathode, and an ionomer containing polymer electrolyte membrane disposed between the anode and the cathode. A cathode catalyst is disposed on the cathode and the cathode catalyst includes PtNiN nanoparticles loaded on mesoporous carbon. At least a portion of the PtNiN nanoparticles are disposed within pores of the mesoporous carbon spaced apart from the ionomer. The PtNiN nanoparticles have an average diameter between about 1.0 nm and about 8.0 nm and at least 90% of the pores of the mesoporous carbon have an average diameter less than about 8.0 nm.

These and other features of the fuel cells will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1A illustrates a PEM fuel cell according to the teachings of the present disclosure;

FIG. 1B illustrates an enlarged view of an interface section labeled 1B in FIG. 1A;

FIG. 1C illustrates an enlarged view of a traditional carbon support particle loaded with Pt-containing nanoparticles at the interface in FIG. 1B;

FIG. 2A illustrates an enlarged view of an interface between the PEM and the cathode for the PEM fuel cell in FIG. 1A according to the teachings of the present disclosure;

FIG. 2B is an enlarged cross-sectional view of a mesoporous carbon particle loaded with Pt-containing nanoparticles according to the teachings of the present disclosure;

FIG. 2C is an enlarged view of section labeled 2C in FIG. 2B;

FIG. 3A show a plot of intensity versus angle for an x-ray diffraction (XRD) scan of a sample containing carbon black particles loaded with PtNiN nanoparticles having an average diameter of about 2.1 nanometers (nm);

FIG. 3B shows a plot of intensity versus angle for an XRD scan of a sample containing mesoporous carbon particles according to the teachings of the present disclosure loaded with PtNiN nanoparticles having an average diameter of about 1.7 nm;

FIG. 3C shows a plot of intensity versus angle for an XRD scan of a sample containing mesoporous carbon particles according to the teachings of the present disclosure loaded with PtNiN nanoparticles having an average diameter of about 7.2 nm;

FIG. 3D shows a plot of intensity versus angle for an XRD scan of a sample containing mesoporous carbon particles according to the teachings of the present disclosure loaded with PtNiN nanoparticles having an average diameter of about 9.3 nm;

FIG. 3E shows a plot of intensity versus angle for an XRD scan of a sample containing commercial mesoporous carbon particles loaded with PtNiN nanoparticles having an average diameter of about 2.4 nm;

FIG. 4 shows a plot of mass activity measured using the rotating disk electrode technique for the samples with XRD scans shown in FIGS. 3A-3E;

FIG. 5 shows a plot of voltage versus current density for the samples with XRD scans shown in FIGS. 3A-3D; and

FIG. 6 shows a plot of mass activity measured using the membrane electrode assembly technique for the samples with XRD scans shown in FIGS. 3A-3D.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

The present disclosure provides an electrode catalyst material (also referred to herein simply as “catalyst material”) and PEM fuel cells with the catalyst material. The catalyst material includes a combination of enhanced mesoporous carbon support particles (also referred to herein simply as “enhanced mesoporous carbon particles” or “enhanced mesoporous carbon”) with pores having an average pore diameter within a predefined range and platinum (Pt) containing nanoparticles having an average particle diameter within a predefined range that is less than or equal to the average pore diameter of the enhanced mesoporous carbon particles. In addition, the Pt-containing nanoparticles are loaded (i.e., positioned) within the pores of the enhanced mesoporous carbon particles such that the Pt-containing nanoparticles are effectively shielded from ionomer poisoning, inhibited from nanoparticle agglomeration, and/or inhibited from nanoparticle growth.

As used herein, the phrase “enhanced mesoporous carbon particles” or “enhanced mesoporous carbon” refers to mesoporous carbon particles with pores and at least 80% of the pores have an average diameter less than or equal to 8.0 nm.

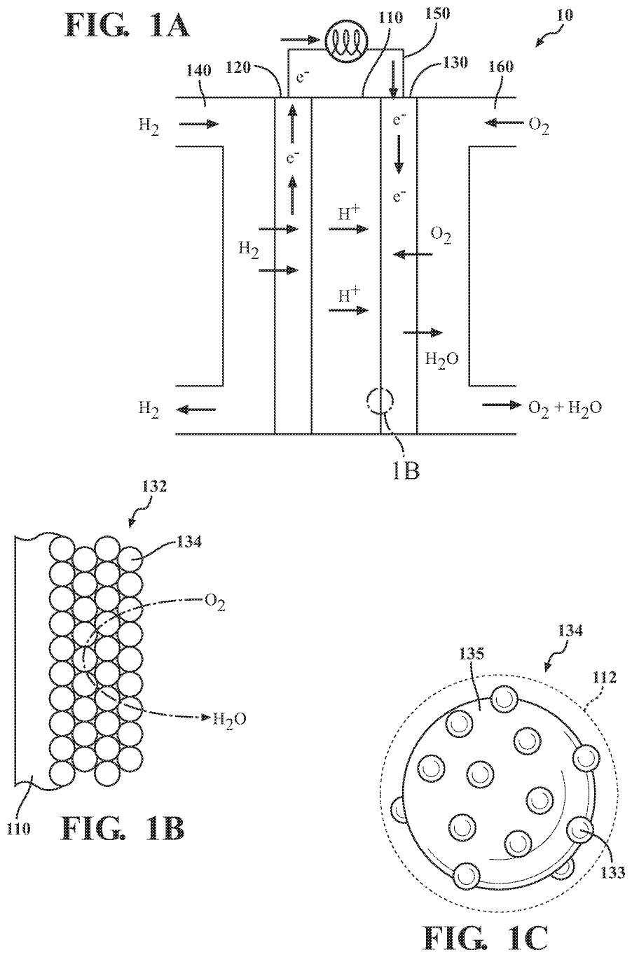

Referring now to FIG. 1A, a PEM fuel cell 10 is shown. The PEM fuel cell includes a PEM 110 sandwiched between an anode 120 and a cathode 130, and an external electrical circuit 150 that electrically connects the anode 120 and the cathode 130. The cathode 130 includes a catalyst layer 132 with a plurality of composite particles 134 as illustrated in FIG. 1B, and the composite particles 134 include a plurality of Pt-containing nanoparticles 133 supported on carbon particles 135 as illustrated in FIG. 1C (only one carbon particle 135 shown).

During operation of the PEM fuel cell 10, hydrogen (H₂) gas is provided to and flows through an anode-side inlet 140 and oxygen (O₂) gas (e.g., O₂ in air) is provided to and flows through a cathode-side inlet 160. At least a portion of the H₂ flows into contact with the anode 120 and migrates to the PEM 110 where H₂ molecules are catalyzed into H⁺ ions plus electrons ‘e⁻’ (e.g., via an anode catalyst layer—not shown). Also, at least a portion of the O₂ gas flows into contact with the cathode and migrates to the PEM 110. The electrons e″ flow through the external electrical circuit 150 to the cathode 130 and react with O₂ molecules to form O²⁻ ions (e.g., via the cathode catalyst layer 132) and the H⁺ ions diffuse through the PEM 110 to the cathode 130 and react with the O²⁻ ions to form H₂O (water), which is then transported out of the PEM fuel cell 10 with the flow of unreacted O₂. In this manner, the Pt-containing nanoparticles 133 assist in and enhance the reaction of O₂+e⁻ to O²⁻ and/or O²⁻+H⁺ to H₂O and electricity is generated by the PEM fuel cell 10.

Referring specifically to FIG. 1C, in some variations an ionomer 112 from the PEM 110 is in contact with and at least partially surrounds the composite particles 134. And in such variations, the ionomer 112 can poison the plurality of Pt-containing nanoparticles 133 (also known as “ionomer poisoning”) such that the efficiency of the catalyst layer 132 decreases. In addition, the plurality of Pt-containing nanoparticles 135 supported on an outer surface of the carbon particle 135 can agglomerate and/or increase in size such that an average effective size of the Pt-containing nanoparticles increases and the efficiency of the catalyst layer 132 decreases. That is, increasing the average particle size of the Pt-containing particles reduces the surface area to volume ratio of the Pt-containing particles, which in turn reduces the surface area available to catalyze the O₂+e⁻ to O²⁻ and/or O²⁻+H⁺ to H₂O reaction(s). Accordingly, ionomer poisoning and nanoparticle growth, either by agglomeration or particle size growth, are problematic for PEM fuel cells.

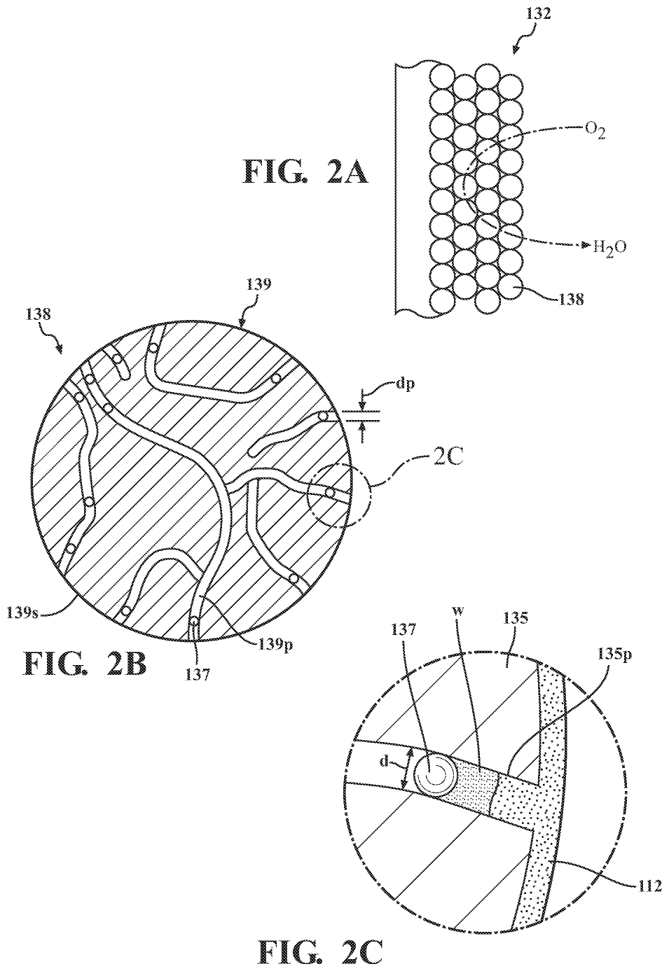

Referring now to FIGS. 2A-2C, the catalyst layer 132 formed from a plurality of composite particles 138 according to the teachings of the present disclosure is shown. The composite particles 138 include a plurality of enhanced mesoporous carbon particles 139 and a plurality of Pt-containing nanoparticles 137 loaded within pores 139p of the enhanced mesoporous carbon particles 139. And while not shown in FIGS. 2B-2C, it should be understood that Pt-containing nanoparticles 137 can be loaded onto and supported by an exterior surface 139s of the enhanced mesoporous carbon particles 139.

A majority of the pores 139p of the enhanced mesoporous carbon particles 139 have an average pore diameter such that the Pt-containing nanoparticles 137 are disposed within the pores 139p with a “tight fit.” As used herein, the phrase “tight fit” refers to a difference between the average pore diameter of the pores 139p and the average diameter of the Pt-containing nanoparticles 137 being less than 10 nanometers (nm). For example, in at least one variation a difference between the average pore diameter of the pores 139p and the average diameter of the Pt-containing nanoparticles 137 is less than 5 nm, and in some variations a difference between the average pore diameter of the pores 139p and the average diameter of the Pt-containing nanoparticles 137 is less than 2.5 nm.

In some variations the Pt-containing nanoparticles 137 are nitrogen-doped platinum nickel (PtNiN) nanoparticles 137 with an average particle size between about 1.0 nm and about 8.0 nm. In some variations, the Pt-containing nanoparticles 137 are generally spherical in shape, while in other variations the Pt-containing nanoparticles 137 are not generally spherical in shape. For example, the Pt-containing nanoparticles 137 are generally cuboidal in shape, generally cylindrical in shape, among others. In at least one variation, the PtNiN nanoparticles 137 are core-shell nanoparticles with a PtNiN core and a Pt shell. In other variations, the PtNiN nanoparticles 137 have a NiN core decorated with islands of Pt and/or PtN. i.e., Pt and/or PtN islands are supported on the NiN Core, and the Pt and/or PtN islands may or may not be discrete nanoparticles.

In variations where the Pt-containing nanoparticles 137 have an average particle size between about 1.0 nm and about 8.0 nm, at least than 85% of the pores 139p of the enhanced mesoporous carbon particles 139 have an average pore diameter less than about 8.0 nm. And in at least one variation, at least 90% of the pores 139p of the enhanced mesoporous carbon particles 139 have an average pore diameter less than about 8.0 nm. For example, in some variations the enhanced mesoporous carbon particles 139 have a pore size distribution of between 5-30% micropores with an average pore diameter less than 2.0 nm, between 50-95% mesoporous with an average pore diameter between 2.0 nm and 8.0 nm, and between 0-25% macropores with an average pore diameter greater than 8.0 nm.

In at least one variation, the enhanced mesoporous carbon particles 139 have a pore size distribution of 10-25% micropores with an average pore diameter less than about 2.0 nm, more than 70% mesopores with an average pore diameter between about 2.0 nm and about 8.0 nm, and less than 10% macropores with an average pore diameter greater than about 8.0 nm. And in some variations, the enhanced mesoporous carbon particles 139 have a pore size distribution of 15-20% micropores with an average pore diameter less than about 2.0 nm, more than 75% mesopores with an average pore diameter between about 2.0 nm and about 8.0 nm, and less than 7.5% macropores with an average pore diameter greater than about 8.0 nm. In addition, the enhanced mesoporous carbon particles have a BET surface area greater than 1,000 m²/g, for example, between about 1,000 m²/g and 2,000 m²/g.

Not being bound by theory, the tight fit between the average pore diameter of the pores 139p and the average diameter of the Pt-containing nanoparticles 137 results in enhanced mass activity of the composite particles 138 due to limited space for the Pt-containing nanoparticles 137 within the pores 139p to agglomerate and/or grow in size. In addition, the tight fit provides or enables a boundary layer of water ‘w’ to be present between the Pt-containing nanoparticles 137 and the ionomer 112 as illustrated in FIG. 2C such that the Pt-containing nanoparticles 137 are spaced apart from the ionomer 112 and thereby are protected or shielded from ionomer poisoning. For example, and as noted above, operation of the PEM fuel cell 10 results in the Pt-containing nanoparticles 137 catalyzing O²⁻ and H⁺ to form H₂O such that water is formed proximate to and displaces ionomer 112 in contact with the Pt-containing nanoparticles 137. Accordingly, the tight fit between the average pore diameter of the pores 139p and the average diameter of the Pt-containing nanoparticles 137 decreases agglomeration and/or growth of the Pt-containing nanoparticles 137, and/or decreases or prevents ionomer poisoning of the Pt-containing nanoparticles 137.

In an effort to better describe the teachings of the present disclosure but not limit the scope in any manner, the synthesis and evaluation of different composite particles are described below.

### Sample Preparation

Precursors of PtNiN catalysts were prepared by dispersing 330 mg of Pt(acac)₂. 220 mg Ni(acac)₂ and 500 mg of carbon support in 80 mL of acetone, followed by sonication for 2 hours. The resulting suspension was kept at room temperature with magnetic stirring for 2 hours and then the resulting mixture was dried by a rotating evaporator device to provide a dried precursor. The dried precursor was then annealed in a tube furnace under flowing NH₃ to obtain samples with different particle sizes and the annealing conditions of the different PtNiN samples were: 500° C. for 2 hours to provide PtNiN nanoparticles with an average diameter equal to 2.6 nm loaded onto ketjenblack EC-300J carbon black particles (Sample 1); 500° C. for 2 hours to provide PtNiN nanoparticles with an average diameter equal to 1.7 nm loaded onto enhanced mesoporous carbon particles (Sample 2); 650° C. for 8 hours to provide PtNiN nanoparticles with an average diameter equal to 7.2 nm loaded onto enhanced mesoporous carbon particles (Sample 3); 650° ° C. for 9 hours to provide PtNiN nanoparticles with an average diameter equal to 9.3 nm loaded onto enhanced mesoporous carbon particles (Sample 4); and 500° C. for 2 hours to provide PtNiN nanoparticles with an average diameter equal to 2.4 nm loaded onto a commercially available mesoporous carbon particles (Sample 5). Table 1 below provides a summary of Samples 1-5.

TABLE 1

| Sample No. | Sample Description |
|---|---|
| 1 | 2.6 nm PtNiN on ketjenblack EC-300J |
| 2 | 1.7 nm PtNiN on enhanced mesoporous carbon |
| 3 | 7.2 nm PtNiN on enhanced mesoporous carbon |
| 4 | 9.3 nm PtNiN on enhanced mesoporous carbon |
| 5 | 2.4 nm PtNiN on commercial mesoporous carbon |

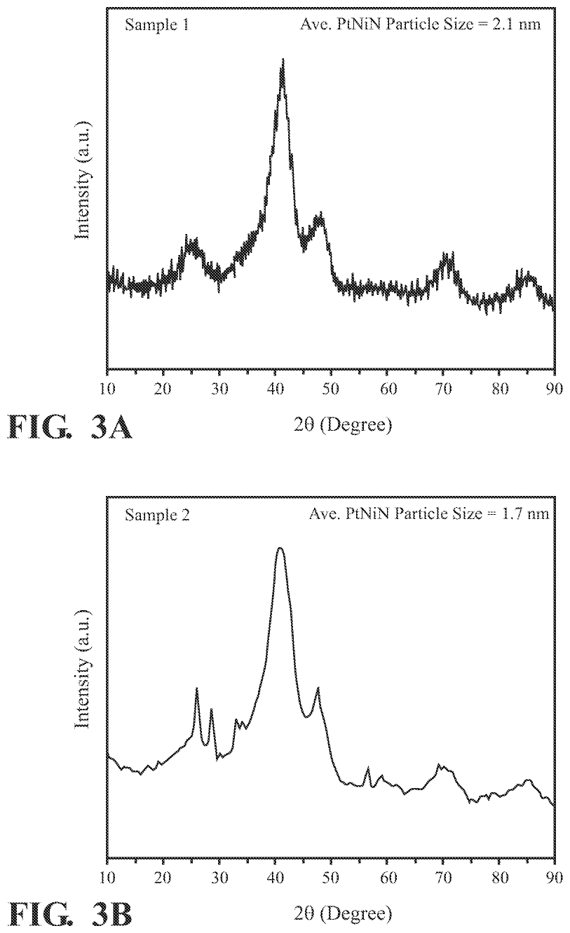

The enhanced mesoporous carbon particles had a BET surface area greater than 1000 m²/g and a pore size distribution of 18.3% micropores with an average pore diameter less than about 2.0 nm, 76.7% mesopores with an average pore diameter between about 2.0 nm and about 8.0 nm, and 5.0% macropores with an average pore diameter greater than about 8.0 nm. The commercially available mesoporous carbon had a BET surface area equal to 815 m²/g and a pore size distribution of 2.7% micropores with an average pore diameter less than about 2.0 nm, 69.9% mesopores with an average pore diameter between about 2.0 nm and about 8.0 nm, and 27.4% macropores with an average pore diameter greater than about 8.0 nm. Also, the average particle size for the PtNiN nanoparticles of each sample was obtained via x-ray diffraction (XRD) with the XRD scan for Sample 1 shown in FIG. 3A, the XRD scan for Sample 2 shown in FIG. 3B, the XRD scan for Sample 3 shown in FIG. 3C, the XRD scan for Sample 4 shown in FIG. 3D, and the XRD scan for Sample 5 shown in FIG. 3E.

### Rotating Disk Electrode (RDE) Testing

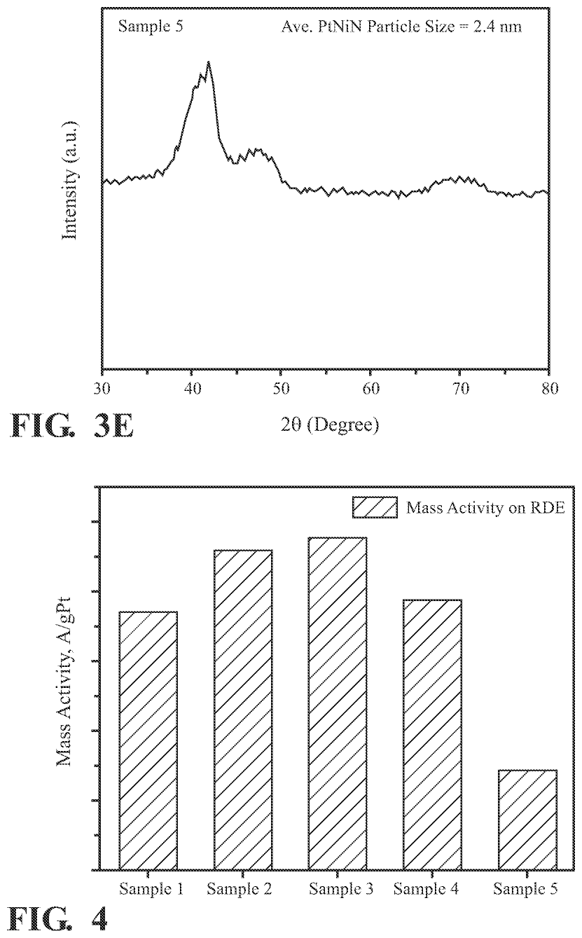

Samples 1-5 were initially evaluated with the RDE technique by dispersing a given sample into a solution containing 4 mL of double distilled water, 2.25 mL isopropanol, and 25 μL Nafion dispersion (DE250) to produce an ink that was subjected to ultrasonication for 60 minutes in an ice bath. A 10 μL of the ink was pipetted onto a glassy carbon disk (5 mm dia., Pinc) and rotationally dried in air to form a uniform catalyst layer. The catalyst coated glassy carbon was pre-conditioned in N₂-saturated 0.1M HClO₄ and then scanned from 0.05 V to 1.2 V with a scan rate of 100 mV/s until the cyclic voltage did not change. Then, oxygen reduction reaction (ORR) measurements were conducted in the N₂-saturated 0.1 M HClO₄ and multiple independent data sets were collected with intrinsic activities corrected with N₂-background and infrared (IR) compensation. The mass activity for the five samples is shown in FIG. 5, and as observed from this figure, small PtNIN nanoparticle size (i.e., less than 3 nm) in combination with carbon black or commercial mesoporous carbon failed to provide a mass activity compared to Samples 2 and 3 which combined PtNIN nanoparticle sizes less than 8 nm with the enhanced mesoporous carbon particles (i.e., mesoporous carbon with 76.7% mesopores having an average pore diameter between about 2.0 nm and about 8.0 nm). Given the relatively poor performance of Sample 5, further testing of this sample was not conducted.

### Membrane Electrode Assembly (MEA) Testing

Samples 1-4 were evaluated with the MEA technique by mixing a given sample with ethanol, water, and ionomer to form an ink. The ionomer to carbon ratio was 0.85 and the ink was vigorously mixed and coated on a poly (tetrafluoro-ethylene) substrate (CARR) using a doctor-blade casting method to form a cathode catalyst material. Similarly, a Pt/C (30 wt. % Pt content, TEC10EA30E, TKK) catalyst layer with an ionomer to carbon ratio of 0.7 was prepared as an anode catalyst material. The coating layer was dried at 80° C. to remove the solvent and the final anode and cathode Pt loading were controlled at 0.05 mg Pt/cm² and 0.1 mg Pt/cm², respectively. Individual cathode and anode electrocatalyst layers (2 cm×2 cm) were punched and a 12 μm think Gore®-Select membrane was sandwiched therebetween to form a catalyst coated membrane using a decal-transfer technique. Hot-pressing of the cathode electrocatalyst layer, Gore membrane, and anode electrocatalyst layer was performed at 130° C. and 0.8 MPa for 5 minutes. Gas diffusion layers (29 BC, SGL Carbon) together with the catalyst coated membrane were assembled in a single cell with a serpentine flow field (Scribner Associates).

Samples 1-4 were evaluated with an 850e Fuel Cell test system (Scribner Associates) for MEA performance evaluation. A given MEA was first activated by sweeping between 0.9 V to 0.1 V for several hundred cycles under H₂/Air (1.5 NLPM/2 NMPM) at 45° C. and 100% relative humidity (RH). Then the current-voltage (i-V) performance of the MEA was evaluated at 80° C. under 90% RH. Ultrapure H₂ and Air (Airgas) were supplied to the anode and cathode, respectively, with an absolute pressure of 200 KPa. The current density was set and increased at 0.05 A/cm² increments until 3 A/cm² was reached and the response voltage was recorded simultaneously. The ORR activities at 0.9 V were obtained from the H₂/O₂ (0.5 NLPM L/2 NLPM) polarization curve at 80° C. 100% RH, and 150 KPa (abs), which was corrected with ohmic resistance and H₂ crossover.

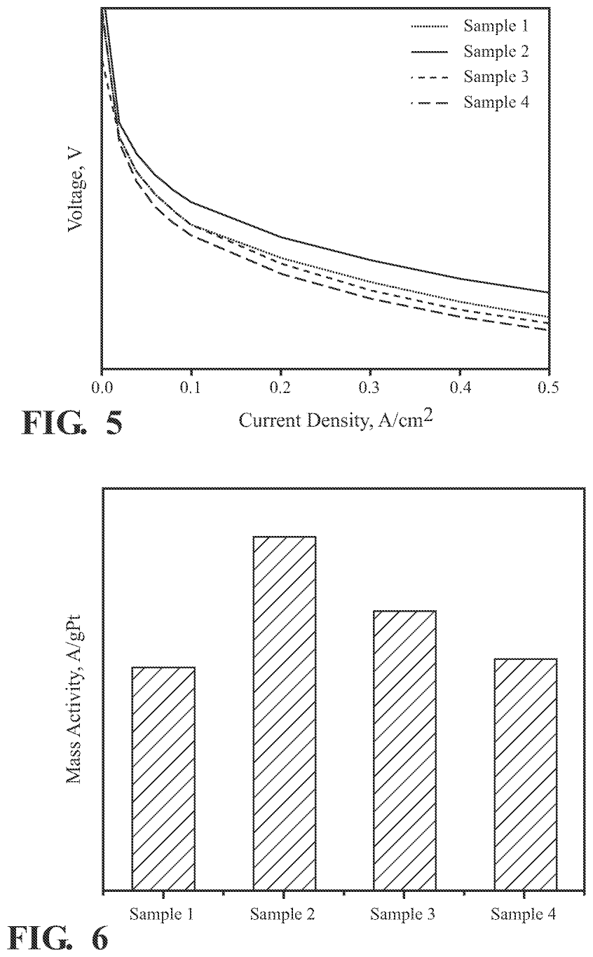

Referring to FIGS. 5 and 6, results of the polarization curve testing with hydrogen and oxygen on Samples 1-4 is shown in FIG. 5 and the mass activity exhibited by Samples 1-4 is shown in FIG. 6. And as observed from FIGS. 5 and 6, the sample with 1.7 nm PtNiN nanoparticles loaded on enhanced mesoporous carbon particles (Sample 2) performed the best. While FIG. 6 does not illustrate actual Mass Activity values for the samples, the Sample 2 exhibited a 59% increase in Mass Activity compared to Sample 1, a 27% increase in Mass Activity compared to Sample 3, and a 53% increase in Mass Activity compared to Sample 4.

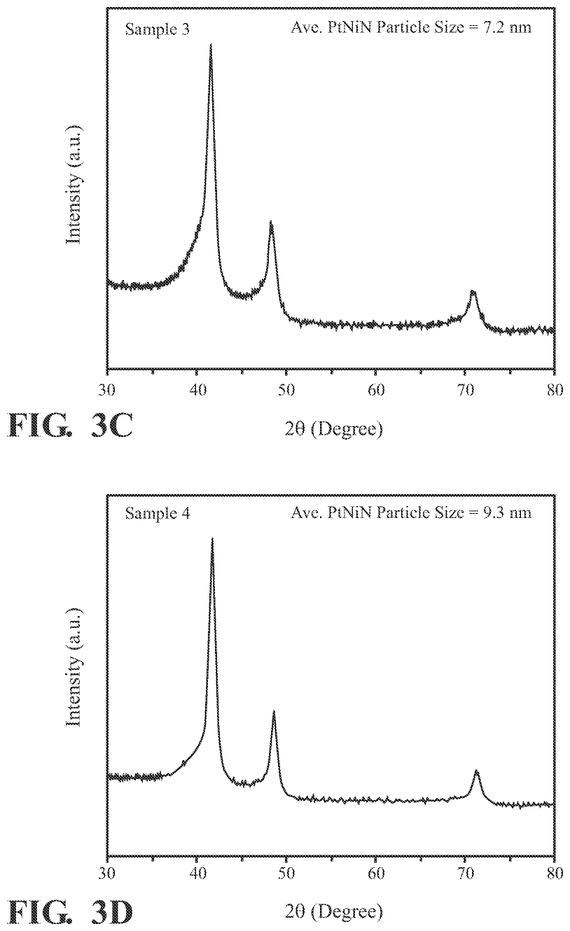

Not being bound by theory, and even though the sample with 7.2 nm PtNiN nanoparticles loaded on enhanced mesoporous carbon particles (Sample 3) had the highest mass activity when evaluated using the RDE technique (FIG. 4), Sample 2 performed the best with MEA testing due to the smaller PtNIN nanoparticle size in Sample 2. That is, a greater percentage of the PtNiN nanoparticles in Sample 3 (7.2 nm) were located outside of the pores of the mesoporous carbon support compared to the PtNiN nanoparticles in Sample 2 (1.7 nm). And PtNiN nanoparticles outside of the pores were in contact with the ionomer which poisons the Pt. In the alternative, or in addition to, PtNiN nanoparticles outside of the pores were not inhibited from agglomeration and/or growth in particle size. Accordingly, the combination of the enhanced mesoporous carbon having pores with an average pore diameter less than or equal about 8.0 nm and the PtNiN nanoparticles having an average particle diameter less than 7.2 nm resulted in an enhanced mass activity for the MEA of Sample 2.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A fuel cell comprising:
an anode, a cathode, and a polymer electrolyte membrane disposed between the anode and the cathode;
a cathode catalyst disposed on the cathode, the cathode catalyst comprising nitrogen doped platinum nickel (PtNiN) nanoparticles loaded on mesoporous carbon, the PtNiN nanoparticles having an average diameter between about 1.0 nm and about 10.0 nm and the mesoporous carbon comprising a plurality of pores with a majority percentage of the plurality of pores having an average diameter less than about 8.0 nm, and at least a portion of the PtNiN nanoparticles disposed within the majority percentage of the plurality of pores having an average diameter less than about 8.0 nm.

2. The fuel cell according to claim 1, wherein the PtNiN nanoparticles have an average diameter between about 1.0 nm and about 8.0 nm.

3. The fuel cell according to claim 2, wherein the PtNiN nanoparticles have an average diameter between 1.7 nm and 7.0 nm.

4. The fuel cell according to claim 1, wherein more than 85% of the plurality of pores of the mesoporous carbon have an average diameter less than about 8 nm.

5. The fuel cell according to claim 1, wherein more than 90% of the plurality of pores of the mesoporous carbon have an average diameter less than about 8 nm.

6. The fuel cell according to claim 5, wherein the plurality of pores of the mesoporous carbon comprises between about 5% and about 30% micropores with an average diameter less than about 2.0 nm.

7. The fuel cell according to claim 6, wherein the plurality of pores of the mesoporous carbon comprises between about 10% and about 25% micropores with an average diameter less than about 2.0 nm.

8. The fuel cell according to claim 7, wherein the plurality of pores of the mesoporous carbon comprises between about 15% and about 20% micropores with an average diameter less than about 2.0 nm.

9. The fuel cell according to claim 5, wherein the plurality of pores of the mesoporous carbon comprises more than 70% mesopores with an average diameter between about 2.0 nm and about 8.0 nm.

10. The fuel cell according to claim 9, wherein the plurality of pores of the mesoporous carbon comprises more than 75% mesopores with an average diameter between about 2.0 nm and about 8.0 nm.

11. The fuel cell according to claim 5, wherein the plurality of pores of the mesoporous carbon comprises less than 10% macropores with an average diameter greater than about 8.0 nm.

12. The fuel cell according to claim 11, wherein the plurality of pores of the mesoporous carbon comprises less than 7.5% macropores with an average diameter greater than about 8.0 nm.

13. The fuel cell according to claim 1, wherein:
the PtNiN nanoparticles have an average diameter between about 1.0 nm and about 8.0 nm;
the plurality of pores of the mesoporous carbon comprises between about 10% and about 25% micropores with an average diameter less than about 2.0 nm;
the plurality of pores of the mesoporous carbon comprises more than 70% mesopores with an average diameter between about 2.0 nm and about 8.0 nm; and
the plurality of pores of the mesoporous carbon comprises less than 10% macropores with an average diameter greater than about 8.0 nm.

14. The fuel cell according to claim 13 further comprising:
a plurality of the PtNiN nanoparticles disposed within the pores of the mesoporous carbon;
water disposed within the pores and in direct contact with the plurality of the PtNiN nanoparticles; and
an ionomer in direct contact with the water.

15. The fuel cell according to claim 1, wherein:
the PtNiN nanoparticles have an average diameter between about 1.7 nm and about 7.0 nm;
the plurality of pores of the mesoporous carbon comprises between about 15% and about 20% micropores with an average diameter less than about 2.0 nm;
the plurality of pores of the mesoporous carbon comprises more than 75% mesopores with an average diameter between about 2.0 nm and about 8.0 nm;
the plurality of pores of the mesoporous carbon comprises less than 7.5% macropores with an average diameter greater than about 8.0 nm;
a plurality of the PtNiN nanoparticles disposed within the pores of the mesoporous carbon;
water disposed within the pores and in direct contact with the plurality of PtNiN nanoparticles; and
an ionomer in direct contact with the water.

16. A fuel cell comprising:
an anode, a cathode, a polymer electrolyte membrane disposed between the anode and the cathode, and an ionomer in contact with the cathode; and
a cathode catalyst disposed on the cathode, the cathode catalyst comprising nitrogen doped platinum nickel (PtNiN) nanoparticles loaded on mesoporous carbon with at least a portion of the PtNiN nanoparticles disposed within pores of the mesoporous carbon spaced apart from the ionomer, the PtNiN nanoparticles having an average diameter between about 1.0 nm and about 10.0 nm and at least 85% of the pores of the mesoporous carbon having an average diameter less than about 8.0 nm.

17. The fuel cell according to claim 16, wherein water is disposed between the at least a portion of the PtNiN nanoparticles disposed within pores of mesoporous and the ionomer.

18. The fuel cell according to claim 17, wherein:
the PtNiN nanoparticles have an average diameter between about 1.7 nm and about 7.0 nm;
the pores of the mesoporous carbon comprises between about 15% and about 20% micropores with an average diameter less than about 2.0 nm;
the pores of the mesoporous carbon comprises more than 75% mesopores with an average diameter between about 2.0 nm and about 8.0 nm; and
the +pores of the mesoporous carbon comprises less than 7.5% macropores with an average diameter greater than about 8.0 nm.

19. A fuel cell comprising:
an anode, a cathode, and a polymer electrolyte membrane comprising an ionomer disposed between the anode and the cathode; and
a cathode catalyst disposed on the cathode, the cathode catalyst comprising nitrogen doped platinum nickel (PtNiN) nanoparticles loaded on mesoporous carbon with at least a portion of the PtNiN nanoparticles disposed with pores of mesoporous and spaced apart from the ionomer, the PtNiN nanoparticles having an average diameter between about 1.0 nm and about 8.0 nm and at least 90% of the pores of the mesoporous carbon having an average diameter less than about 8.0 nm.

20. The fuel cell according to claim 19, wherein:
water is disposed between the at least a portion of the PtNiN nanoparticles disposed with pores of mesoporous and the ionomer;
the PtNiN nanoparticles have an average diameter between about 1.7 nm and about 7.0 nm;
the plurality of pores of the mesoporous carbon comprises between about 15% and about 20% micropores with an average diameter less than about 2.0 nm;
the plurality of pores of the mesoporous carbon comprises more than 75% mesopores with an average diameter between about 2.0 nm and about 8.0 nm; and
the plurality of pores of the mesoporous carbon comprises less than 7.5% macropores with an average diameter greater than about 8.0 nm.
